(19) United States
(12) Patent Application Publication
(10) Pub. No.: US 2007/0011259 A1
(43) Pub. Date: Jan. 11, 2007

(54) Secure messaging and data transaction system and method

(75) Inventor: George F. McNulty, Eden Prairie, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Caveo Technology, Inc.

(21) Appl. No.: 11/455,578

(22) Filed: Jun. 19, 2006

Related U.S. Application Data
(60) Provisional application No. 60/692,104, filed on Jun. 20, 2005.

(51) Int. Cl. G06F 15/16

(52) U.S. Cl. 709/206

(57) ABSTRACT

A secure messaging system and method is provided for secure end-to-end messaging solutions for data transaction inside and outside an organization. With such secure messaging, communications are safely stored within an encrypted database. Users are presented with a secure Web-based front-end that looks and functions like a traditional email that is familiar to an email user. In one embodiment, only delivery notifications of messages appear in a user's email inbox with a link that directs the user to a system portal for secure viewing. The messages are securely entered via a Web interface and then sent directly to a staging server. The staging server sends the intended recipient an unencrypted email informing the recipient that there is a secure message waiting to be picked up. The recipient can click on an embedded hyperlink, authenticates and securely views the message as a Web page via a secure connection.

### CROSS-REFERENCE TO RELATED APPLICATION(S)

This application claims priority to U.S. provisional patent application Ser. No. 60/692,104, filed Jun. 20, 2005, which is incorporated herein by reference in its entirety.

### FIELD OF THE INVENTION

The present invention relates to a secure messaging system and method. More particularly, the present invention relates to a secure messaging system and method for providing secure end-to-end messaging solution for data transaction inside and outside an organization.

### BACKGROUND OF THE INVENTION

Today the most common message options are assumed to be insure email or no email at all. Traditional emails do not guarantee the security of someone's mailbox. Messages and attachments can be read by others, system administrators or even forwarded. This insecurity has raised violation of policies in some industries, such as in the healthcare industry under the HIPAA regulations. Email and electronic collaboration between patients, physicians and healthcare organizations (HCO) becomes more and more popular and desirable. Under one survey, 56% of patients indicate the ability to communicate with their physician online would influence their choice of physician or health plan, see Taylor, H. and R. Leitman (2002), Patient/Physician Online Communication. The HIPPA regulations generally require that much of this type of communication be encrypted and not available through unsecured means.

Traditionally, healthcare organizations authorize access to, authenticate requests for, and securely transmit data via one of the following means: 1) Public Key Infrastructure (PKI), such as Entrust, Verisign, VisionShare, etc., wherein PKI issues and manages private certificates for authentication, signatures and encryption; 2) Customized Legacy (CL), such as Microsoft, Novell, IBM, etc. wherein CL customizes and extends existing legacy messaging tools to users outside the firewall; 3) Content Filtering (CF), such as Tumbleweed, Sigaba, PostX, etc., wherein CF scans outbound traffic for PHI information, and messages believed to contain PHI are sent utilizing S/MIME plus X.509; and 4) Staging Server (SS), such as Kryptiq, ZixCorp, etc., wherein messages are encrypted, and SS acts as an intermediary Web-based transaction broker for all messaging and data traffic between participants. However, the SS does not provide secure message data store in an intermediary Web-based transaction, and the SS does not operate in a secure message network community. In addition, the SS does not provide a HIS (Health Information Systems) integration, and the SS does not secure inbound messages. Further, the SS does not provide synchronous LDAP (Lightweight Directory Access Protocol) lookup.

Therefore, there is a need in the art for a secure messaging system and method which provides improved secure end-to-end messaging solutions for data transaction inside and outside an organization.

### BRIEF SUMMARY OF THE INVENTION

The present invention provides a secure messaging system and method for secure end-to-end messaging solutions for data transaction inside and outside an organization. With such secure messaging, communications are safely stored within an encrypted database. Users are presented with a secure Web-based front-end that looks and functions like a traditional email that is familiar to an email user.

In one embodiment of the present invention, only delivery notifications of messages appear in a user's email inbox with a link that directs the user to a system portal for secure viewing. The system and method in accordance with the present invention can be used for secure internal and external communications, electronic file transfers (including EDI (Electronic Data Interchange) and attachments) and for a healthcare provider, patient and payer communications. Because the system and method of the present invention are Web-based, it has the advantages of scalability, integration and cost.

In one embodiment of the present invention, messages are securely entered via a Web interface, and then sent directly to a staging server. The staging server then sends the intended recipient an unencrypted email informing the recipient that there is a secure message waiting to be picked up. The recipient can click on an embedded hyperlink, authenticates and securely views the message as a Web page via a secure connection.

Accordingly, the system and method in accordance with the principles of the present invention limits communication only to authorized users, business partners, and between authorized relationships. It also allows message and system administrators to facilitate message responses and data management without viewing message content, thereby maintaining confidentiality. Further, it integrates with existing email services including Microsoft® Exchange, Novell®, GroupWise®, and IBM® Lotus Notes®. Furthermore, its customizable interface for the unique healthcare organization ensures consistent branding, and it supports secure transfer of electronic files and attachments. Moreover, it allows an organization or user to archive and prune message data according to organization defined requirements. In addition, the system's flexible transaction logging engine is capable of monitoring and time-stamping all transaction activities.

In one embodiment of the secure messaging system in accordance with the principles of the present invention, the system is customizable and expandable as it has an independent platform which allows for seamless integration with existing HIS and portal environments, automating back-end processes resulting in greatly reduced time and cost spent on non-revenue generating activities. The system allows for single sign-on for physicians, staff and patients. Also, the customizable workflow matches and automates interactions and enables great personalized care by automating patient reminders for scheduled appointments, medication notices and prescription refill notices. Further, messages can be exported to patient data records for permanent archive. In one embodiment, the system includes a secure portal, a scalable solution for integrating and delivering Web applications. Furthermore, the system is capable of having multi-language support from a single edition.

Accordingly, the present invention provides many key advantages or benefits. For example, one of advantages is that security and privacy are ensured because patients, staff and business partners see only what they are authorized to see, and unlike traditional email. Therefore, sensitive messages and attachments are contained within a secure server and never a vulnerable mailbox.

Another advantage of the secure messaging system and method in accordance with the principles of the present invention is that it saves time by allowing only authorized access and eliminating SPAM and messages from unauthorized users.

A further advantage of the secure messaging system and method in accordance with the principles of the present invention is that the secure messaging system and method has consistent branding and seamless integration with other portals which improves productivity, while the Web interface is instantly familiar to a user and requires nothing to be downloaded or installed.

A yet another advantage of the secure messaging system and method in accordance with the principles of the present invention is that the secure messaging system is a directory-based user repository system which can be readily synchronized with the other systems, thereby saving time and reducing errors caused by re-entering user information.

A yet additional advantage of the secure messaging system and method in accordance with the principles of the present invention is that the secure messaging system saves cost by easily scaling to support large numbers of users, and by automating data archiving and transaction logging management.

A further advantage of the secure messaging system and method in accordance with the principles of the present invention is that the secure messaging system improves patient care by increasing the communication between a patient and a provider, and enables greater personalized healthcare without adding cost.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 illustrates an exemplary secure messaging method in accordance with the principles of the present invention.

FIG. 2A illustrates a block diagram of one embodiment of a secure messaging system in accordance with the principles of the present invention.

FIG. 2B illustrates a schematic view of one embodiment of a secure messaging system in accordance with the principles of the present invention.

FIG. 3 illustrates an exemplary secure messaging system having different services modules in accordance with the principles of the present invention.

FIG. 4 illustrates a flow chart of an exemplary secure messaging method in accordance with the principles of the present invention.

FIG. 5 illustrates an exemplary secure messaging system having a manage directory in accordance with the principles of the present invention.

FIG. 6 illustrates an exemplary secure messaging system having a manage user inbox in accordance with the principles of the present invention.

FIG. 7 illustrates an exemplary secure messaging system having application settings in accordance with the principles of the present invention.

### DETAILED DESCRIPTION

While, the present invention is particularly suitable for use in the healthcare industry so as to enable easy and secure healthcare communications, it may also be applied to many other industries for easy and secure communications.

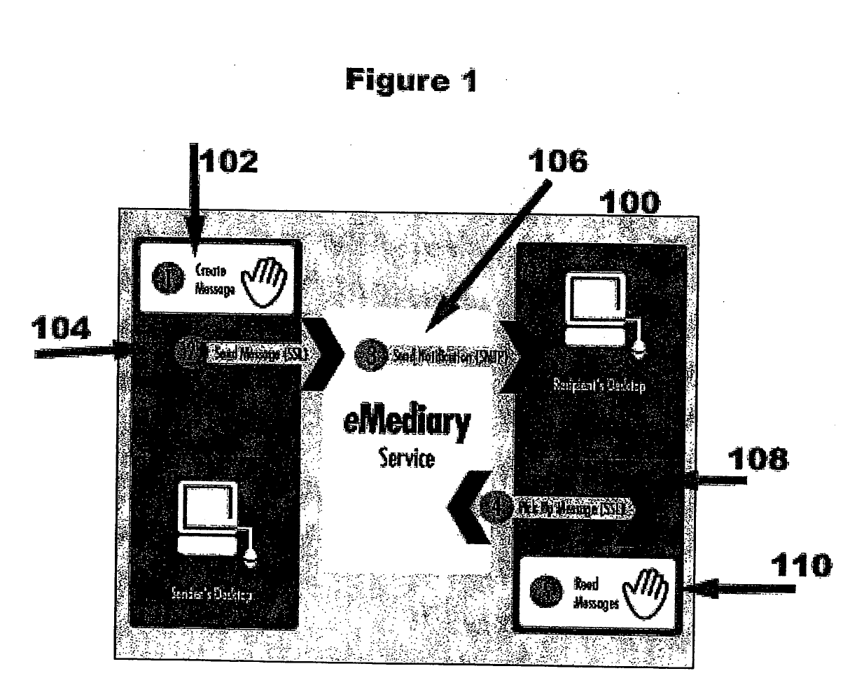

FIG. 1 shows one embodiment of an exemplary secure messaging process 100 in accordance with the principles of the present invention. All messages are conducted in a secure browser-based session that is policy-enforced for authentication, administration and authorization privileges of a user. A user first creates a message in a step 102 and then sends off the message in a step 104. A secure messaging system sends an invitation or unencrypted email to a recipient that can be delivered and read by the recipient in a step 106. The recipient picks up the message by clicking on an embedded hyperlink within an invitation email that connects the recipient in a secure browser-based session in a step 108, where the recipient is authenticated for viewing, replying and administering the message. Once authenticated, the recipient reads the message in a step 110.

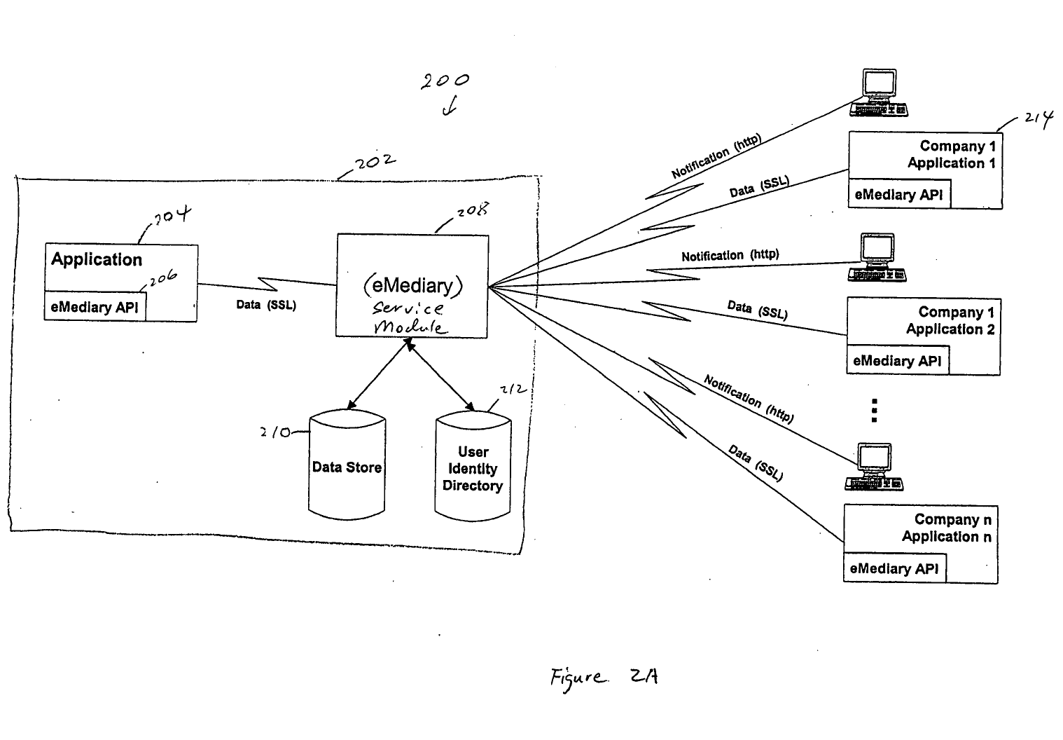

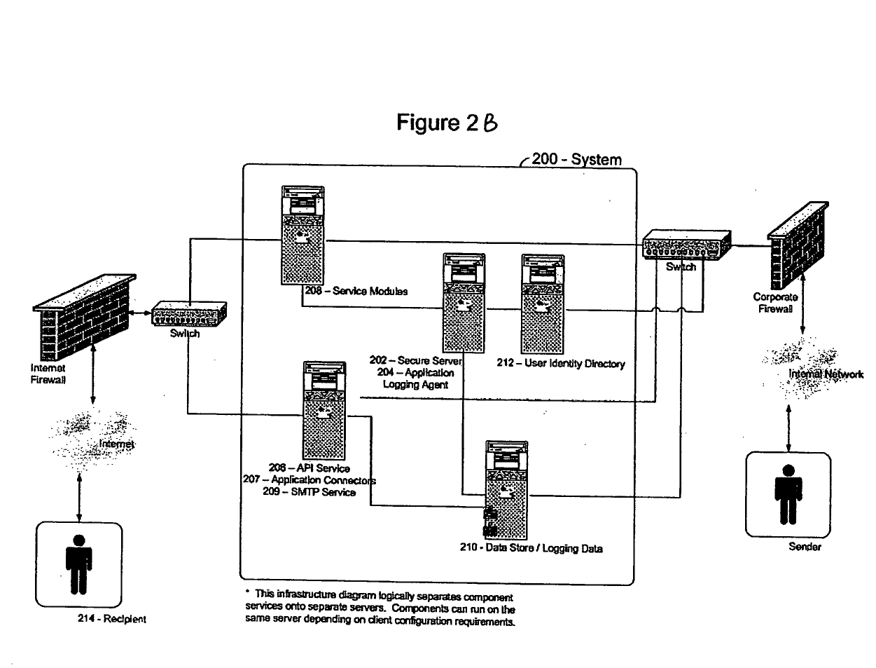

FIGS. 2A and 2B show one embodiment of a secure messaging system 200 in accordance with the principles of the present invention. The system 200 includes a secure server 202 having a secure messaging application 204, an example of which is a secured Application Program Interface (API) 206 applicable in healthcare industry. The system 200 also includes a service module 208, for example, a service module applicable in healthcare industry, for authenticating a sender, for storing data in a data storage 210, for storing obtaining one or more recipient addresses via a user identity directory 212, and for logging all activities in a user identity directory 212. Accordingly, when a user creates a message, the application 204 generates data which is then sent to the service module 208 via the secured API 206. The data is sent using a Secure Sockets Layer (SSL), such as https. The service module 208 authenticates the sender, receives the data, stores the data in the data storage 210, obtains a recipient address via the user identity directory 212, and logs activities. It is appreciated that the service module 208 may be arranged and configured such that the data is optionally stored in the data storage 210, and that the user identity directory 212 optionally stores all or some of the activities. In one embodiment, since the message is treated as “data”, the system is able to use the API to integrate with a range of data storage options.

Also in FIGS. 2A and 2B, the service module 208 sends an http notification to a recipient 214 that data has been received and is ready to be retrieved. The notification includes an embedded link or hyperlink that connects the recipient 214 to a secure browser-based session, wherein the recipient 214 is authenticated for viewing, replying and administering the message. Once the recipient 214 clicks the embedded link, the system initiates a secure browser-based session. Once the recipient 214 is authenticated, the service module 208 sends the data to the recipient 214. It is appreciated that the sender may send the message to more than one recipient. The system will initiate a secure browser-based session for each recipient. Each user is authenticated for viewing, replying, and administering. Once authenticated, the data will be sent to each user.

The secure messaging system of the present invention is arranged such that it allows for infrastructure independence and near-universal integration. Its platform, database and directory independence allows the industry, such as the healthcare industry, to manage the secure messaging system on the existing healthcare system.

The secure messaging system may include a Web interface which is used to allow a universal view for all users, including senders and receivers inside and outside of a system firewall. The interface may utilize a standard browser in a Secure Socket Layer (SSL) session offering multi-bit encryption, e.g. 128-bit encryption. By utilizing a Web-based interface, any PC or Mac or equivalent computer with any form of Internet connectivity can securely and effortlessly access and view the information anywhere and anytime. This offers a significant value over some proprietary systems that require a separate presence on a desktop.

Also, the secure messaging system may include a standard mail transfer agent with structural features built on the platform. This not only allows the system to act as a mail relay agent but also provides for additional features and functionalities, such as simplified, yet effective, authorization and authentication procedures, GUI policy enforcement interface, and user-friendly inbox.

Further, the secure messaging system may include a management component that provides organizations with clearly defined auditing, configuration management, logging, data management, user-management controls and administrative rights.

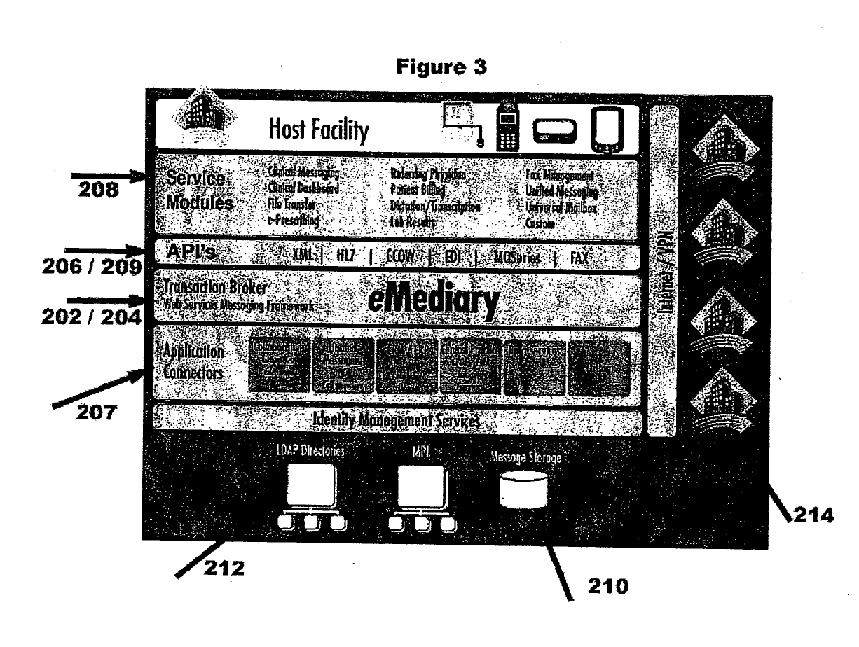

FIG. 3 illustrates the secure messaging system having different services modules 208. For example, service modules may include at least one of the following modules: a clinical messaging module, a clinical dashboard module, a file transfer module, an e-Prescribing module, a referring physician module, a patient billing module, a dictation/transcription module, a lab result module, a fax management module, a unified messaging module, a universal mailbox module, and a custom module. It is appreciated that other suitable modules can be implemented within the scope of the present invention.

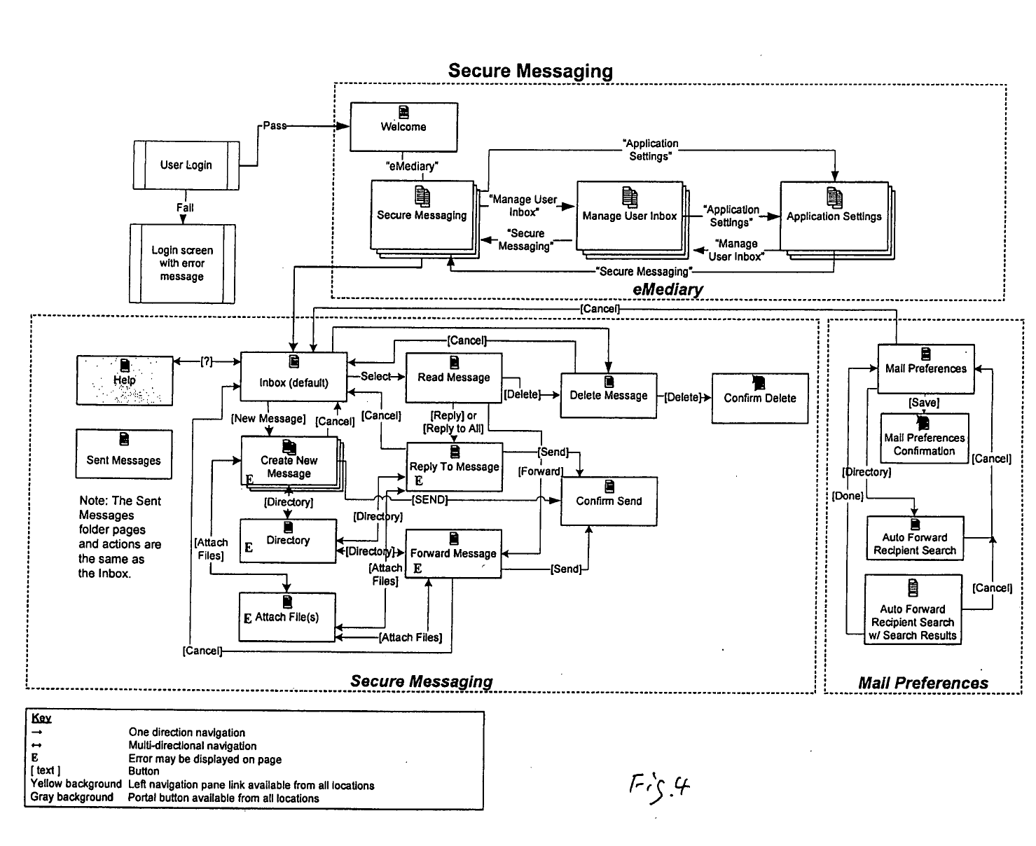

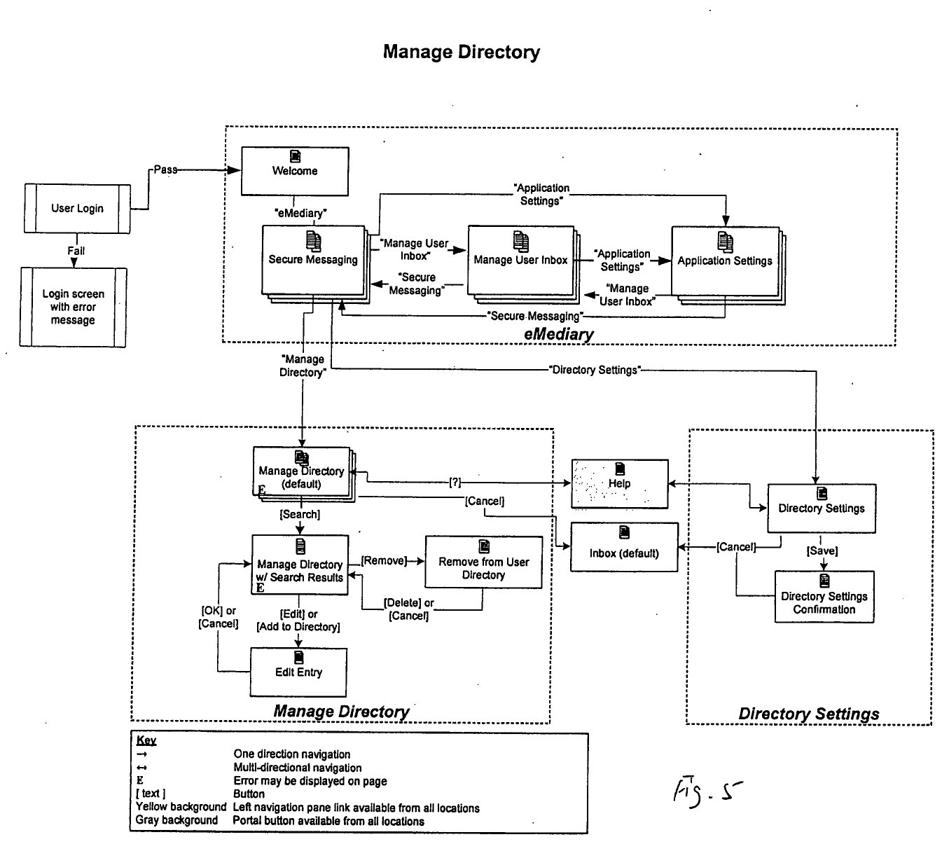

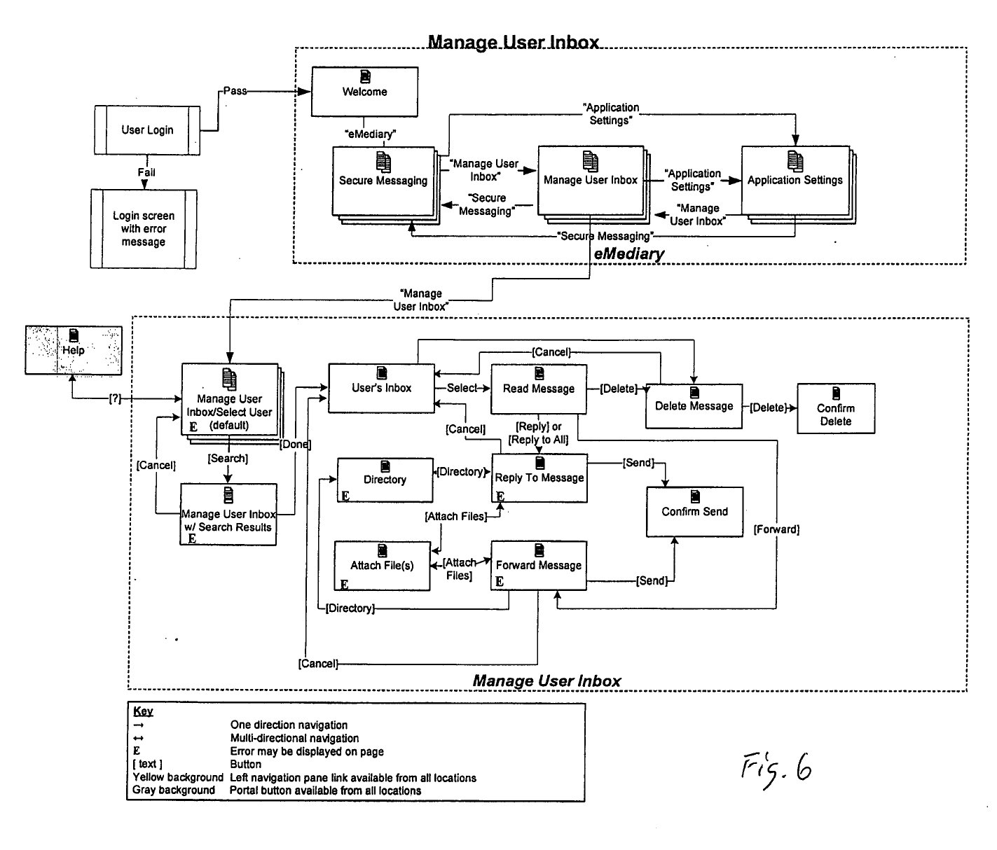

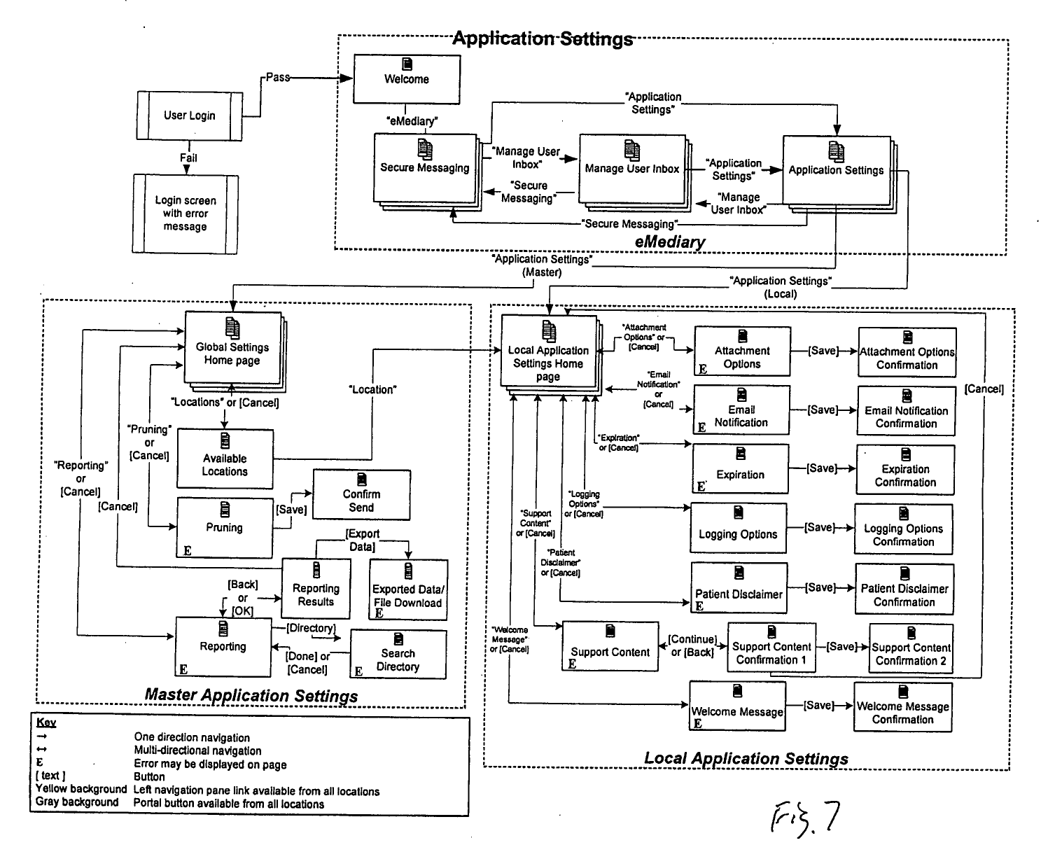

FIG. 4 shows an exemplary secure messaging method, and FIGS. 5-7 illustrate an exemplary secure messaging system having a manage directory, a manage user inbox, and application settings in accordance with the principles of the present invention.

Although the present invention has been described with reference to preferred embodiments, persons skilled in the art will recognize that changes may be made in form and detail without departing from the spirit and scope of the invention.

What is claimed is:

1. A method of secure messaging, comprising:
creating a message;
sending the message to a service module;
sending an unencrypted electronic notification to a recipient, the unencrypted notification including an embedded link;
clicking on the embedded link;
connecting the recipient to a secure browser-based session;
authenticating the recipient; and
sending the message to the recipient once the recipient is authenticated.

2. A secure messaging system, comprising:
a secure server having a secure messaging application; and
a service module communicating with the secure server, for authenticating a message sender, storing obtaining one or more recipient addresses via a user identity directory, and logging activities.

3. The system of claim 2, wherein the service module stores the data in a data storage.

4. A method of secure messaging, comprising:
creating a message by a sender;
sending the message to a service module via a secure socket layer (SSL);
sending an unencrypted email to a recipient, the unencrypted email including an embedded hyperlink;
clicking on the embedded hyperlink within the email;
connecting the recipient to a secure browser-based session;
authenticating the recipient for viewing, replying and administering the message; and
sending the message to the recipient once the recipient is authenticated for viewing, replying and administering the message.
